(19) United States
(12) Patent Application Publication
(10) Pub. No.: US 2014/0036955 A1
(43) Pub. Date: Feb. 6, 2014

(54) Device And Method For The Photothermic Investigation Of A Sample

(71) Applicants: Martin Brunner, Konradsreuth (DE); Juergen Blumm, Selb (DE); Thomas Denner, Selb (DE); Robert Campbell, Duxbury, MA (US); Thilo Hilpert, Selb (DE); Michael Gebhardt, Selb (DE); Stefan Lauterbach, Selb (DE); Andreas Strobel, Auerbach (DE); Juergen Tschoepel, Arzberg (DE); Matthias Schoedel, Schwarzenbach (DE); Andre Lindemann, Merseburg (DE); Andreas Hartinger, Roeslau (DE)

(72) Inventors: Martin Brunner, Konradsreuth (DE); Juergen Blumm, Selb (DE); Thomas Denner, Selb (DE); Robert Campbell, Duxbury, MA (US); Thilo Hilpert, Selb (DE); Michael Gebhardt, Selb (DE); Stefan Lauterbach, Selb (DE); Andreas Strobel, Auerbach (DE); Juergen Tschoepel, Arzberg (DE); Matthias Schoedel, Schwarzenbach (DE); Andre Lindemann, Merseburg (DE); Andreas Hartinger, Roeslau (DE)

(21) Appl. No.: 13/955,627

(22) Filed: Jul. 31, 2013

(30) Foreign Application Priority Data
Jul. 31, 2012 (DE) 102012106955.7

(51) Int. Cl. G01N 21/17

(52) U.S. Cl. CPC G01N 21/1717
USPC 374/131

(57) ABSTRACT

A device for the photothermic investigation of a sample, with an excitation source for generating an electromagnetic excitation beam directed onto an excitation side of the sample, a detector for detecting thermal radiation emitted by a detection side of the sample, and a temperature-controllable sample chamber with a sample holder accommodated therein for the arrangement and temperature control of the sample. According to the invention, provision is made such that an adjustable detection lens system is provided between the sample holder and the detector, the detection lens system being adjustable in order to adjust a desired field of vision of the detector on the sample surface.

### FIELD OF THE INVENTION

The present invention relates to a device for the photothermic investigation of a sample and method.

### BACKGROUND OF THE INVENTION

Such a device and such a method are known for example from product brochure “LFA 447 Nano Flash®” from the company Netzsch-Gerätebau GmbH, Selb, Germany, (retrievable on the Internet on 04.07.2012 at http://www.netzsch-thermal-analysis.com/download/LFA_{—}447_NanoFlash_D_{—}1108_de_{—}180.pdf). The known device comprises:
a xenon flash lamp as an excitation source for generating an excitation beam directed onto a front side of the sample to be investigated, said front side functioning as an “excitation side”,
an infrared detector for detecting thermal radiation emitted by a “detection side”, here the rear side of the sample, and
a sample chamber in the form of an electrically operated oven with a sample holder for the arrangement and temperature control of a plurality of samples, said sample holder being accommodated in said oven and constituted as a “sample changer”.

With the known device, measurements of the thermal conductivity or thermal diffusivity of the sample between room temperature and 300° C. are made possible through the use of the oven.

The design of the sample holder as a sample changer permits a simultaneous arrangement of a plurality of samples in the sample chamber, one of which can be selected in each case as the sample currently to be measured. This has the advantage that, for example, the sample that is actually to be investigated can be measured together with one or more reference samples (with known physical properties) as part of a software-controlled measurement program, wherein the temperature in the sample chamber for example is gradually changed over a predetermined temperature range.

In order to achieve a high measurement accuracy, it has proved to be advantageous if the infrared detector or its radiation-sensitive region is disposed as close as possible to the rear side of the sample currently being investigated, in order to detect the thermal radiation emitted by the rear side of the sample as completely as possible and, as far as possible, not to allow any thermal radiation resulting from the heating of the oven to reach the detector. The latter “interfering radiation” is in practice the reason why the temperature range of the known device is limited to 300° C. An even higher temperature of the sample or of the interior of the sample chamber would result in an unacceptable increase in the proportion of the interfering radiation with regard to the requirements of high measurement accuracy.

Moreover, it needs to be taken into account that an increase in the maximum sample temperature that can be approached operationally would usually require an enlarged overall length of the sample chamber, as a result of which the distance between the sample and the detector would also be increased. For a given “viewing angle” of the detector (within which the detector detects thermal radiation), this means that there would be a tendency for more interfering radiation to be able to travel from the sample chamber “past the sample” to the detector. It is true that the latter can be avoided by the use of suitably dimensioned and disposed apertures. However, in view of the different sample sizes and thicknesses, a dimensioning and arrangement of such apertures that is fitting in each case is not without problems in practice. If such an aperture arrangement is to be adapted, for example manually by a user, this represents a certain expense and also a source of error.

### SUMMARY OF THE INVENTION

It is a problem of the present invention to enable, with a device and a method of the kind mentioned at the outset, still higher sample temperatures with at the same time a high measurement accuracy and reproducibility in the photothermic investigation.

In the case of the device according to the invention, this problem is solved by the fact that an adjustable detection lens system is provided between the sample holder and the detector, said lens system being able to be adjusted in order to adjust a desired field of vision of the detector on the sample surface.

The term “detection lens system” is intended here to denote any optical imaging system formed by one or more, refractive or reflective optical elements, wherein the “adjustment of a desired field of vision” of the detector means that, through an adjustment of the lens system (e.g. by translation of one or more optical elements), it is possible to change the area on the sample surface (in the region of the “detection side”) from which thermal radiation arrives at the radiation-sensitive region of the detector on account of the optical imaging. This area on the sample surface thus defined by the state of adjustment of the detection lens system is the “field of vision”. Thermal radiation emitted from the detection side of the sample from outside the adjusted field of vision, on the other hand, does not reach the detector and is not therefore detected.

If, with the device according to the invention, the essentially entire area of the detection side of the sample (e.g. one of the two flat sides of a plate-shaped sample) can for example be adjusted as the field of vision of the detector, the detection of interfering radiation from the sample chamber can thus advantageously be greatly suppressed and at the same time a large proportion of the thermal radiation emitted by the detection side of the sample can be conveyed to the detector.

The solution according to the invention on no account rules out one or more apertures being used in the region between the sample to be investigated and the detector in order in this way also to avoid the detection of interfering radiation.

A sample chamber expediently having larger dimensions for higher sample temperatures and the accompanying increase in the distance between the sample and the detector can within the scope of the invention be accepted, inasmuch as a “narrowing of the viewing angle” of the detector can be achieved by the detection lens system, as a result of which thermal radiation (interfering radiation) resulting from the heating of the sample chamber is prevented from propagating as far as the detector.

The invention thus makes it possible to carry out photothermic investigations, in particular at high sample temperatures, with a high measurement accuracy and a high degree of reproducibility.

A further advantage of the invention consists in the fact that a spatially resolved detection of the thermal radiation emitted by the sample can be achieved with an adjustability of a field of vision which is smaller than the total area of the detection side of the sample.

A further advantage arises especially in the case where samples of differing size and/or differing thickness are to be investigated, whether it be in the course of separate measurement procedures or in a joint measurement during one and the same measurement procedure (e.g. as part of a software-controlled measurement program, using a “sample changer”): If, for example, samples of differing thickness are being investigated, this may be accompanied by a change in the optical-geometrical conditions from sample to sample, so that with unchanged optical imaging the size of the field of vision on the sample surface is thus also changed. This effect, which is often very undesirable in practice, can however easily be compensated for by the adjustability of the detection lens system and thus of the field of vision as provided for according to the invention.

The adjustment of the detection lens system can take place manually or, for example, automatically in a software-controlled manner. In this connection, it should be noted that dimensional parameters, such as for example the size and the thickness of the sample, are usually known, so that these parameters can be taken into account in a manual adjustment by a user or in an automatic adjustment in a program-controlled measurement procedure (after inputting of such parameters by the user), in order to adjust a field of vision that is desirable for a specific sample.

In an examination of a plurality of samples differing in respect of their dimensions, an adjustment of the field of vision of the same magnitude in each case can in particular thus be achieved.

In connection with two-dimensionally extending samples, the flat side onto which the electromagnetic excitation beam is directed is also referred to below as the “front side” (and the other flat side accordingly as the “rear side”).

This terminology or definition is however purely arbitrary and serves merely for a more graphic designation of the respective flat sides.

In an embodiment of the invention, a first flat side (“front side”) of a two-dimensionally extending, e.g. plate-shaped sample is provided as the excitation side and a second flat side (“rear side”) of the sample facing away from the first flat side is provided as the detection side.

In this case, thermal radiation emitted by the rear side is detected by the detector, said thermal radiation having been produced by the heating caused by the excitation beam on the front side (after propagation of one or more heat pulses or heat waves through the sample).

In another embodiment, the excitation side and the detection side of the sample are identical, i.e. are formed by one and the same “sample side”. In the case of a two-dimensionally extending, e.g. plate-shaped sample, this means that both the electromagnetic excitation and the thermal radiation detection take place on the same flat side (“front side”).

In this case, thermal radiation emitted by the front side is detected by the detector, said thermal radiation having been produced in dependence on the heating likewise caused by the excitation beam on the front side. In particular, samples can thus also be investigated with which the heat generated by the excitation beam is not propagated or is propagated only very slowly and/or weakly through the sample.

The use of the invention is not restricted to certain kinds of sample. Apart from solid (e.g. metallic) samples, therefore, liquid or powdery samples or samples having an internal structure (e.g. built up in layers), for example, can also be investigated. For the design of suitable sample receptacles of the sample holder in each particular case, recourse can advantageously be taken to sample holder designs known per se from the prior art. For non-solid samples (e.g. liquid or powdery samples), terms relating here to the sample shape, such as flat side, front side, rear side, plate-shaped etc., relate to the shape of the sample concerned such as it is in the investigation situation. In this sense, plate-shaped liquid samples, for example, can also be investigated.

With regard to the storage of such shape-variable samples, for example in a roughly tank-shaped sample receptacle, provision can be made such that the electromagnetic excitation and/or the thermal radiation detection takes place at a sample side adjacent to a tank wall of the sample receptacle. With an excitation of the sample in the region of such a wall, it is possible, for example by a suitable selection of the tank material, to ensure that the excitation beam is propagated notably through the tank material up to the sample. Alternatively or in addition, a notable absorption of the excitation beam in the tank material can however also be provided for (its temperature variation thus produced then leads via thermal conduction to a corresponding temperature variation of the sample material). The same applies to the thermal radiation detection. A direct detection of the thermal radiation of a sample side adjacent to tank material requires a corresponding permeability of the tank material for the thermal radiation. Alternatively or in addition, the thermal radiation detection can however also take place partially indirectly, in that temperature variations or thermal radiation fractions of the tank material that are caused by temperature variations of the sample side concerned are detected by the detector.

The adjustable detection lens system can comprise one or more refractive optical elements, such as for example spherical or aspherical lenses. Alternatively or in addition, reflective optical elements (e.g. spherical or aspherical mirrors) can also be used as components of the detection lens system.

Each refractive optical element should be produced from a material which has as high a transmission as possible in the region of the expected spectrum of the thermal radiation to be detected. In this regard, such elements can be produced for example from a material based on Ge, ZnSe, ZnS, CaF₂ or Mg F₂.

In the case of reflective optical elements, a correspondingly high reflectance in the relevant spectral region can be achieved by a suitable surface coating.

Provision is made in an embodiment such that each optical element of the adjustable detection lens system has a transmission coefficient (or reflection coefficient) of at least 0.6, preferably at least 0.8, at least one point in the wavelength interval from 2 μm to 6 μm.

In an embodiment, the adjustable detection lens system is constituted such that the whole or only a part of the detection side of the sample to be investigated optionally lies in the field of vision of the detector depending on the adjustment of this lens system.

As already mentioned, a manual adjustment of the detection lens system is possible within the scope of the invention, for example by the fact that (at least) one optical element of the detection lens system mounted displaceably in a checked manner is displaced manually, or an optical element is replaced by another optical element (e.g. with another focal point), or an optical element mounted in an element holding fixture, such as for example a plug-in support, is “translated” from an element holding fixture provided for this into an element holding fixture disposed at another point.

Preferably, however, a controllable, in particular software-triggered controllable (e.g. electromotive or e.g. hydraulic) drive is provided for the displacement of (at least) one optical element of the detection lens system, in order to adjust the detection lens system for the adjustment of the desired field of vision.

If one or more apertures are provided between the sample holder and the detector for the purpose of suppressing interfering radiation, it should not be ruled out within the scope of the invention that the adjustment of the detection lens system involves, in addition to the displacement of at least one refractive or reflective optical element, also a joint displacement of at least one such aperture.

In an embodiment, a linear drive for example is provided as the drive, by means of which a change in the distance between an optical element of the detection lens system and the sample and/or a change in the distance between an optical element of the detection lens system and the detector is possible. The optical element concerned can be mounted for this purpose, for example, in a linear guide and so as to be displaceable in the direction of an optical element axis, wherein the controllable drive is suitably coupled with the optical element or an element holding fixture.

As an alternative or in addition to an automatic adjustment by translation of (at least) one optical element along its optical axis, a (e.g. software-triggered controllable) driven element change can also be provided, wherein (at least) one optical element of the detection lens system is replaced by (at least) one other optical element. In this embodiment, a plurality of optical elements or detection lens systems can as it were be held ready in the device and exchanged as required during the ongoing investigation process. An embodiment that is particularly straightforward in terms of design makes provision in this regard for a so-called revolver. With such a revolver, a plurality of optical elements with parallel optical axes can be disposed along a circle or an arc of circle (spaced apart from one another in the circumferential direction) and can be brought in each case, as required, into the detection-side beam path of the device by means of a corresponding rotation about an axis (a revolver axis), which runs parallel to the optical axes and through the circle centrepoint. Alternatively or in addition to a rotation of the revolver for the purpose of exchanging elements, a controllably driven translation of the revolver in the direction of the revolver axis can be provided for the purpose of translation of the element located in the beam path.

If the adjustment of the detection lens system involves the possibility of an exchange of an optical element, the optical elements held ready can differ from one another, in particular in their focal length. As an alternative or in addition, consideration can be given to holding ready optical elements with optical transmission properties differing from one another (for example reflection properties in the case of reflective elements), in order for example to take account of the fact that the spectral composition of the thermal radiation to be detected depends to a certain extent on the sample currently to be investigated and the given sample temperature.

As an alternative to a revolver, wherein the element exchange takes place by means of a rotation, a plurality of optical elements with optical axes parallel to one another, but spaced apart from one another along a straight section, can also be provided, so that an element exchange can be carried out by translatory displacement of the arrangement.

Provision is made in an embodiment such that the temperature-controllable sample chamber is constituted in such a way that the temperature control of the sample to a sample temperature of more than 300° C., in particular more than 400° C., is possible.

The term “sample chamber” denotes a spatial region of the device that is provided to accommodate the sample holder and is temperature-controllable with an essentially constant temperature. In an embodiment, the sample chamber is essentially completely closed, i.e. surrounded by sample chamber walls. Such a closed sample chamber can for example comprise a temperature-control jacket (containing heating and/or cooling devices) and closure walls at the ends. If the excitation and/or the detection is provided through such an end wall, the wall concerned can be constituted as a “radiation window”, i.e. with sufficient optical transmission for the radiation concerned.

Provision is made in an embodiment such that the sample holder is constituted for the simultaneous arrangement of a plurality of samples in the sample chamber and means are provided for the selection, in each case, of one of these samples as a sample currently to be investigated.

For example, such a “multiple sample holder” can be provided with a plurality of sample receptacles, whereof one of the samples accommodated in the plurality of sample receptacles as a sample currently to be investigated can be positioned, by means of a suitable actuation of the sample holder (e.g. by a rotation and/or displacement thereof), at a point at which the excitation beam strikes the sample and the field of vision of the detector is directed onto the sample.

In this sense, it is thus possible, for example, to provide a fixed optical excitation/detection path, which runs from the excitation source (e.g. flash lamp, laser, etc.) via the sample holder to the detector, wherein the sample currently to be measured is shifted into this fixed path, in that the sample holder of the sample chamber (together with sample holders contained therein) is suitably moved for this purpose. A “revolver” can again be provided for example in this regard (as already described above for the detection lens system), in order to move a sample to be selected at the time into or out of the excitation/detection path. As an alternative to a rotation, a translatory movement of a sample holder can be considered, said sample holder comprising a plurality of sample receptacles disposed in a row.

In another embodiment, the sample holder is also constituted as a multiple sample holder, but it is stationary, wherein for the selection of one of the accommodated samples as a sample currently to be investigated, a corresponding movement of the “excitation and detection arrangement”, i.e. the excitation source together with any provided excitation-side lens system and the detector together with a detection lens system, is provided relative to the (stationary) samples. With this embodiment, the optical excitation/detection path is shifted as it were towards the respective sample (and not vice versa).

As already mentioned, the excitation side and the detection side of the sample can be formed by different sides of the sample, i.e. front side and rear side. In this case, the previously mentioned excitation/detection path runs from the excitation source to the front side of the sample and from the rear side of the sample onward to the detector. The excitation side and the detection side of the sample can however also be formed by one and the same sample side, or the front side of the sample. In this case, the mentioned excitation/detection path runs from the excitation source to the front side of the sample and onward from the front side of the sample to the detector. According to a variant of embodiment, provision can be made here such that the excitation beam irradiates the whole of the front side of the sample. Alternatively, only a part is irradiated (“excitation spot”). Similarly, two possibilities exist for the detection of the thermal radiation, detecting this thermal radiation for the whole of the front side of the sample or only for a part of the front side of the sample (“detection spot”). If an excitation spot and a detection spot are provided, the latter are spaced apart from one another on the sample surface according to an embodiment. A constitution of the excitation/detection path wherein the detection spot overlaps with or is identical to the excitation spot is however also conceivable.

According to a further aspect of the invention, the initially stated problem with a method of the type mentioned at the outside is solved by the fact that a desired field of vision of the detector on the sample surface is adjusted by means of an adjustable detection lens system provided between the sample holder and the detector.

The embodiments and particular design features described above for the device according to the invention can also be provided in a similar manner individually or in any suitable combination for the method according to the invention.

Thus, provision can for example be made with the method such that a first flat side (front side) of a two-dimensionally extending sample is provided as the excitation side and a second flat side (rear side) of the sample facing away from the first flat side is provided as the detection side.

Furthermore, provision can for example be made such that the adjustment of the detection lens system is carried out depending on the dimensions (e.g. size and/or thickness) of the sample to be investigated.

This is for example very advantageous when samples of differing size and/or differing thickness are investigated simultaneously in a measurement program running in a software-controlled manner and an adjustment of the detection lens system automated by the software during the course of the measurement program is carried out. It is thus possible, for example, to keep the field of vision or, for example, a radius of the field of vision constant for all the samples in the case of samples of differing thickness by means of a suitable adjustment of the detection lens system.

Provision is made in an embodiment such that, in the case of an adjustment of the detection lens system wherein only a part of the detection side of the sample to be investigated is adjusted as the field of vision, a photothermic investigation of the sample is carried out involving scanning the sample in a spatially resolved manner.

In particular, a “matrix measurement” of the sample or of a plurality of samples accommodated on the sample holder can take place at the detection side, wherein in the case of a plurality (samples changed in the course of the measurement program), a uniform (detection-side) spatial resolution of the measurement for the various samples can advantageously be carried out by keeping the field of vision constant. Alternatively, however, the invention also advantageously makes it possible for a field of vision preselected individually by the user or software for controlling the measurement sequences to be adjusted for each sample to be investigated.

By means of a preferably program-controlled control device, all the controllable device components can be controlled according to a preselected measurement program, wherein previously entered user inputs (e.g. concerning the nature and/or dimensions of the sample(s)) can also be taken into account as part of a software control. Furthermore, parameters can for example be inputted, with the aid of which the desired measurement (sample) temperatures are fixed (e.g. with a maximum measurement temperature of more than 300° C., in particular more than 400° C.). Finally, parameters concerning the excitation can also be inputted, for example to establish a power or a time-related power variation of the excitation source (e.g. in the case of a pulsed light source: pulse duration, pulse interval and/or pulse energy).

In an embodiment of the investigation method, provision is made such that the temperature-controlled sample chamber is controlled in such a way that a temperature control of the sample takes place to a sample temperature of more than 300° C., in particular more than 400° C., for example to approx. 500° C.

### BRIEF DESCRIPTION OF THE DRAWINGS

The invention is described in greater detail below with the aid of an example of embodiment making reference to the appended drawings. In the figures:

FIG. 1 shows a diagrammatic representation of an example of embodiment of a device for the photothermic investigation of samples,

FIG. 2 shows a magnified detail representation of FIG. 1 to illustrate an adjustment of a detection lens system, wherein beam paths of the thermal radiation resulting for two different adjustments are entered, and

FIG. 3 shows a representation similar to FIG. 2 but with an illustration of the influence of a “viewing angle region” of a detector used with the device of FIG. 1 depending on the adjustment of the detection lens system.

### DETAILED DESCRIPTION OF THE INVENTION

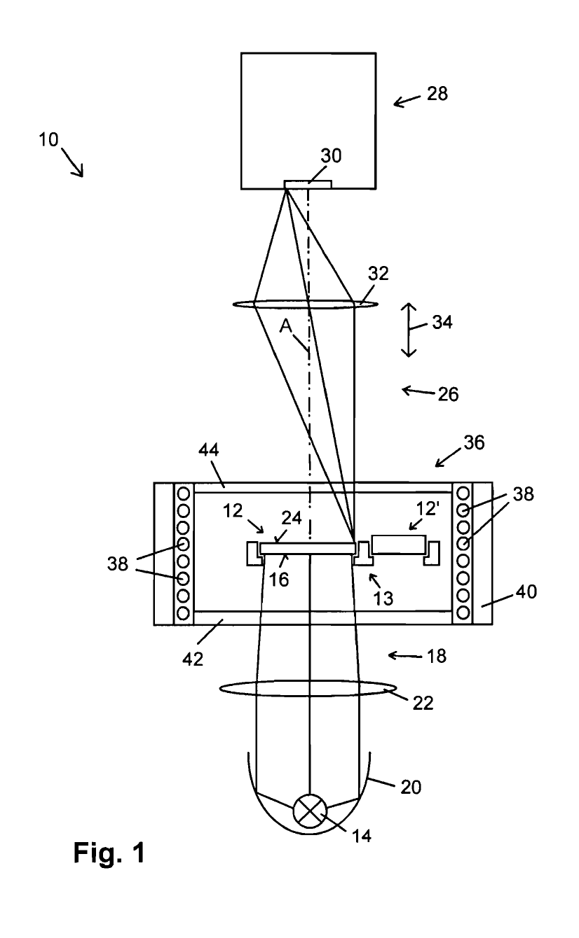

FIG. 1 shows an example of embodiment of a device 10 for the photothermic investigation of samples 12, 12′, which are accommodated in sample receptacles of a multiple sample holder 13 of device 10 provided for this purpose. Sample 12 is being investigated in the situation represented in the figure.

Device 10 further comprises a high-power xenon flash lamp 14 operated in a pulsed mode as an excitation source for generating an electromagnetic excitation beam 18 directed onto a front side 16 of sample 12. The energy of the individual excitation pulses amounts to approx. 10 J and can be set by the user on a program-controlled control device (not represented). As part of selectable measurement programs, this control device controls the operation of all the controllable components of device 10.

In the represented example, pulsed excitation beam 18 is directed by means of a reflector 20 and a collimation or focusing lens 22 onto sample front side 16 acting as the “excitation side”, wherein in the represented example the entire area of sample front side 16 is irradiated uniformly (see flashlight beams drawn in FIG. 1). Diverging from this, however, a smaller region of sample front side 16 could also be irradiated.

In a development of the invention, the “excitation lens system”, i.e. lens 22 for example in the represented example of embodiment, is provided so as to be adjustable, such that an adjustment of the region on the excitation side of the sample to be irradiated with the excitation beam can be carried out. Similar to the adjustment of the detection lens system, the excitation-side adjustment can if need be also be carried out as part of the measurement program sequence (e.g. software-controlled).

The individual “heat pulses” (excitation beam 18) of flash lamp 14 produce a time-dependent (here: pulsed) heating of sample front side 16, so that proceeding from the latter a heat pulse propagation through the material of sample 12 results.

In a manner known per se, therefore, an investigation (“photothermic investigation”) of physical properties of sample 12 can thus be carried out by detecting thermal radiation 26 emitted as a result of this heat pulse on rear side 24 of sample 12. Physical variables that can thus be measured are in particular the thermal conductivity or thermal diffusivity of the (e.g. homogeneous) sample material concerned. According to a specific embodiment of the photothermic investigation, this method can even allow conclusions to be drawn as to the internal structure of the investigated sample.

In a very simple variant of the method, both the electromagnetic excitation, at the sample front side in the represented example, and the thermal radiation detection, at the sample rear side in the represented example, takes place without spatial resolution, i.e. distributed or cumulatively over the entire front side and rear side of the sample concerned. The thermal conductivity or the thermal diffusivity of samples made of homogeneous material, for example, can be ascertained very precisely with this method.

In the represented example, a (preferably cooled) infrared detector 28 with a radiation-sensitive detector region 30 is provided for the detection of thermal radiation 26 emitted by sample rear side 24, wherein an adjustable detection lens system is provided between sample holder 13 and detector 28 or its detector region 30, said detection lens system being adjustable for the adjustment of a desired, preferably circular “field of vision” of detector 28 on sample rear side 24.

The adjustable detection lens system can, as represented, comprise a lens 32 displaceable in the direction of an optical axis A or can be formed by one such lens. The displaceability of lens 32 is symbolised in FIG. 1 an arrow 34. An automatic displacement of lens 32 is brought about by a linear drive coupled with a lens mount and acting in the direction of optical axis A (not represented in FIG. 1).

With the adjustability of the detection lens system, here lens 32, a “zoom lens system” is produced, by means of which it is possible to ascertain the region from which emitted thermal radiation arrives at detector region 30. In this connection, it is important that sample holder 13 is housed in a temperature-controllable sample chamber 36 in device 10, in order to carry out a desired temperature control of samples 12, 12′ to be investigated as part of the measurement program, so that there is in principle the risk of undesired “interfering radiation” (caused by heating of sample chamber 36) also arriving at detector region 30.

In the represented example, a jacket of sample chamber 36 comprises electrically operated heating elements 38 and, optionally, a cooling passage 40 through which a coolant can flow in a controlled manner.

In the represented example, the end faces of sample chamber 36 are formed by optical filters 42 (on the excitation side) and 44 (on the detection side). Their filter characteristics are provided such that a transmission is produced, as far as possible, only for the spectral region to be expected in each case, i.e. on the one hand for the spectrum of excitation beam 18 (filter 42) and on the other hand for the spectrum of thermal radiation 26 (filter 44).

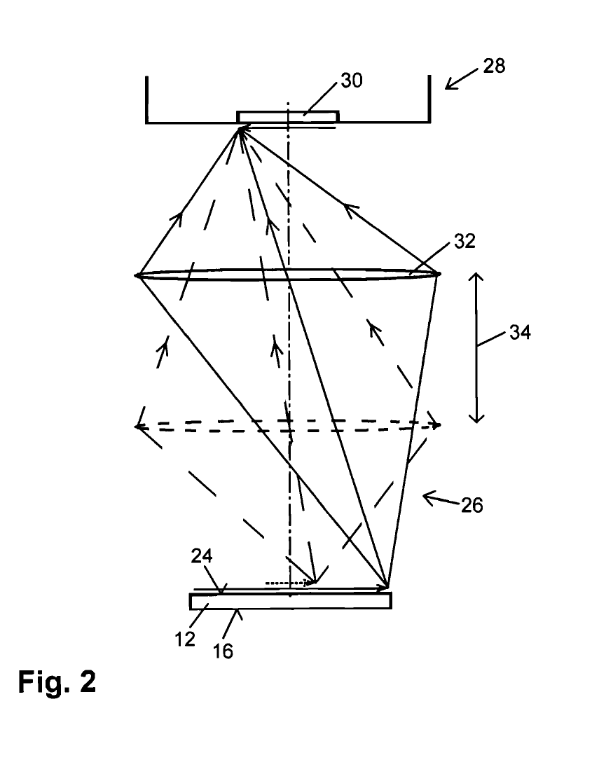

FIG. 2 illustrates the mode of functioning of the “zoom lens system” (here: adjustable lens 32) with the aid of a magnified detail representation.

With the adjustment of lens 32 represented by solid lines in FIG. 2, (entire) rear side 24 of sample 12 (see solid “object arrow”) is imaged onto the area of radiation-sensitive detector region 30. With this adjustment, therefore, the whole of the thermal radiation emitted by sample rear side 24 is detected by detector 28. Any thermal radiation from the sample chamber going “past the sample” is advantageously not imaged by this optical system onto detector region 30. A detection of such “interfering radiation” is thus advantageously suppressed.

After an adjustment of lens 32 into the position represented by dashed lines, only a part of sample rear side 24 (see dashed smaller “object arrow”) is now imaged onto the area of radiation-sensitive detector region 30. This adjustment can also be advantageously used, for example, to carry out an investigation of sample 12 involving scanning on the detection side in a spatially resolved manner. Interfering radiation passing sample 12 is advantageously also suppressed with this adjustment.

A spatially resolved scanning photothermic investigation of sample 12 can be carried out in this situation, for example, in such a way that the position of sample 12 is displaced step by step in transverse direction(s), i.e. at right angles to optical axis A, in order in this way to measure separately the thermal radiation emitted from different points of sample rear side 24. Especially in the case of such a measurement method, focusing of excitation beam 18 onto a small part (“spot”) of sample front side 16 can also be advantageous on the excitation side.

Even though it is not represented in the figure, detector 28 can advantageously comprise a fixed aperture in the region in front of its radiation-sensitive region 30, by means of which aperture an angular region (e.g. “viewing angle cone”) of detector 28 is defined, within which radiation can travel to radiation-sensitive region 30. The effect of such a detector aperture in connection with the usual detection lens system should be provided in such a way that the desired adjustment effect of the detection lens system is not thereby impaired.

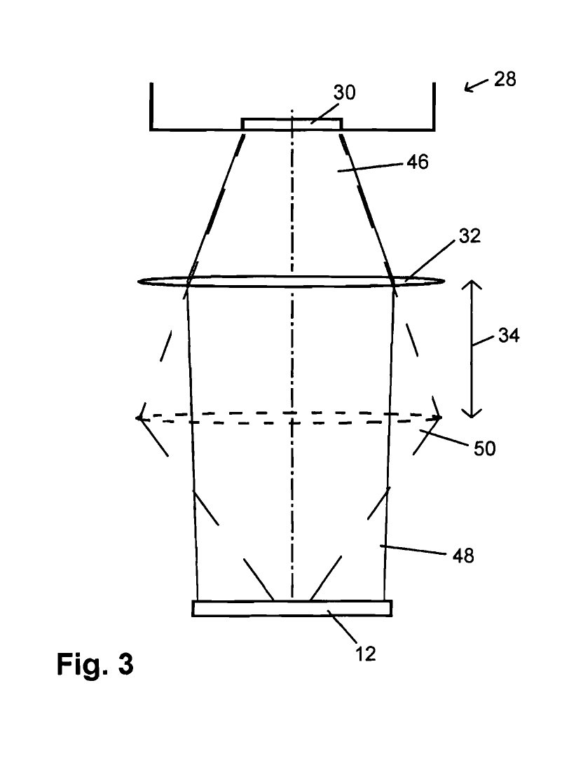

FIG. 3 illustrates once again the mode of functioning of the “zoom lens system” with another approach. Represented here is a “viewing angle region” 46 of detector 28, which is transformed into a “narrowed viewing angle region” 48 or 50 in the region of sample 12, said narrowing differing in degree depending on the position of lens 32.

To sum up, an adjustable detection lens system (zoom lens system) is used on the detector side in device 10, so that the field of vision of the detector resulting on the sample currently to be investigated can be advantageously varied. Thus, for example, it is possible by means of electronics or software to respond in particular to different sample sizes and thicknesses. If, for example, a change from represented sample 12 to (thicker) sample 12′ takes place in the measurement procedure (e.g. in an automated manner), a somewhat smaller field of vision would result on sample 12′ (than on sample 12) with an unchanged detection lens system. If desired, this effect can however be advantageously compensated for by a suitable (preferably automated) adjustment of the detection lens system. If, for example, field of vision magnitudes kept constant in this way are provided for the different samples, measurement results that are more readily comparable can thus be obtained for the different samples.

1. A device for the photothermic investigation of a sample, with an excitation source for generating an electromagnetic excitation beam directed onto an excitation side of the sample, a detector for detecting thermal radiation emitted by a detection side of the sample, and a temperature-controllable sample chamber with a sample holder accommodated therein for the arrangement and temperature control of the sample,
characterised in that an adjustable detection lens system is provided between the sample holder and the detector said lens system being adjustable in order to adjust a field of vision of the detector on the sample surface, in such a way that, depending on the adjustment of this lens system, the whole of or only a part of the detection side of the sample to be investigated optionally lies in the field of vision of the detector.

2. The device)$ according to claim 1, wherein a first flat side of a two-dimensionally extending sample is provided as the excitation side and a second flat side of the sample facing away from the first flat side is provided as the detection side.

3. The device according to claim 1, wherein the detection lens system comprises at least one reflective optical element.

4. The device according to claim 1, wherein the adjustable detection lens system is constituted in such a way that a replacement of at least one optical element of the detection lens system by at least one other optical element is thus enabled.

5. The device according to claim 1, wherein a linear drive is provided, by means of which a change in the distance between an optical element of the detection lens system and the sample and/or a change in the distance between an optical element of the detection lens system and the detector is possible.

6. The device according to claim 1, wherein the temperature-controllable sample chamber is constituted such that the temperature control of the sample to a sample temperature of more than 300° C., in particular more than 400° C., is possible.

7. The device according to claim 1, wherein the sample holder is designed for the simultaneous arrangement of a plurality of samples in the sample chamber and means are provided for selecting, in each case, one of these samples as a sample currently to be investigated.

8. A method for the photothermic investigation of a sample, wherein an electromagnetic excitation beam is directed onto an excitation side of the sample and thermal radiation emitted by a detection side of the sample is detected by means of a detector, wherein the sample is held and temperature-controlled on a sample holder accommodated in a temperature-controllable sample chamber,
characterised in that a field of vision of the detector on the sample surface can be adjusted by means of an adjustable detection lens system provided between the sample holder and the detector, in such a way that, depending on the adjustment of this lens system, the whole of or only the part of the detection side of the sample to be investigated optionally lies in the field of vision of the detector.

9. The method according to claim 8, wherein the adjustment of the detection lens system is carried out in dependence on the dimensions, in particular a size and/or thickness, of the sample to be investigated.

10. The method according to claim 8, wherein, in the case of an adjustment of the detection lens system wherein only a part of the detection side of the sample to be investigated is adjusted as the field of vision, a photothermic investigation of the sample is carried out involving scanning the sample in a spatially resolved manner.
